(19) United States
(12) Patent Application Publication
(10) Pub. No.: US 2006/0263042 A1
(43) Pub. Date: Nov. 23, 2006

(54) Method and apparatus for recording non-recorded part of broadcast program

(75) Inventors: Oh-hyun Kwon, Suwon-si (KR); Sung-min Jeon, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/340,727

(22) Filed: Jan. 27, 2006

(30) Foreign Application Priority Data
May 18, 2005 (KR) 10-2005-0041763

(51) Int. Cl. H04N 5/91

(52) U.S. Cl. 386/83

(57) ABSTRACT

A method and apparatus for recording a non-recorded part of a partially recorded broadcast program, e.g., the recording starts from the middle of the broadcast program, is provided. The broadcast program recording apparatus includes a control unit, which when a broadcast program that a user is watching is selected to be recorded and at least a part of the broadcast program is not recorded, requests a program compensator to compensate for the non-recorded part of the broadcast program; the program compensator recording the non-recorded part of the broadcast program at the request of the control unit; and a storage unit storing the recorded broadcast program. If a user instantly wants to record a broadcast program, the broadcast program recording apparatus compensates for a non-recorded part of the broadcast program before the recording started, thereby completely recording the broadcast program.

### BACKGROUND OF THE INVENTION

This application claims the priority of Korean Patent Application No. 10-2005-0041763, filed on May 18, 2005, in the Korean Intellectual Property Office, the disclosure of which is incorporated herein in its entirety by reference.

1. Field of the Invention

The present invention relates to a method and apparatus for recording a broadcast program, and more particularly, to a method and apparatus for recording a non-recorded part of a broadcast program when the broadcast program is not wholly but partly recorded, e.g., the recording starts from the middle of the broadcast program.

2. Description of the Related Art

Owing to a development of digital broadcasting, the demand for a personal video recorder (PVR) has increased. The PVR records a broadcast signal that is MPEG-compressed in a built-in or built-out storage medium such as a hard disk or an optical disk drive and reproduces the broadcast signal stored in the storage medium.

A broadcast program using the PVR may be recorded in two ways: (1) scheduling recording of a desired broadcast program before the desired broadcast program is broadcasted and performing the scheduled recording; and (2) recording a broadcast program being currently broadcasted when a user wants to record the broadcast program.

A method of schedule-recording a broadcast program using a conventional PVR will now be described. First, broadcast signals including video/audio/data are transmitted from a broadcasting station, and an electronic program guide (EPG) including information about a broadcast program, for example, broadcast channel information, a broadcast program title, recording time, etc. is obtained from the broadcast signals. A user may register the scheduled recording of a desired broadcast program using the EPG. Information about the scheduled recording, which is registered by the user, is stored in an electrically erasable and programmable read only memory (EEPROM), a non-volatile memory of the PVR digital broadcast recording apparatus, in the order of scheduled record time.

Then, when a system of the PVR digital broadcast recording apparatus is turned on or off, a MICOM of the PVR digital broadcast recording apparatus enters a standby state. At a scheduled recording start time of the broadcast program that the user wants to record, the system is turned on, and the system tunes a channel on which a program scheduled to be recorded is transmitted using the information stored in the EEPROM. Next, the program scheduled to be recorded is recorded on a hard disk HDD of the PVR digital broadcast apparatus, and when the recording time ends, the recording is finished. After information corresponding to a program recorded completely is deleted from the EEPROM, it is determined whether another program is scheduled to be recorded next. When such a program exists, the program is registered as the first program for recording and a scheduled record time of this program is set in the MICOM. Then, the system of the PVR digital broadcast recording apparatus is turned off, and enters a standby state. When there is no program to be recorded next, the system is completely turned off. The above operations are terminated after being repeatedly performed until the recording of all scheduled programs registered by a user is completed.

As described above, according to the conventional broadcast program recording method, the whole content of the selected program can be recorded. However, when the user realizes he/she wishes to record the broadcast program while he/she is watching it and immediately starts to perform the recording, the user cannot record the part of the broadcast program that was broadcasted before the recording starts. Similarly to this, the user may intend not to record the broadcast program that he/she is watching but later regret not having recorded it at the end of the broadcast program.

Accordingly, the conventional broadcast program recorder inconveniences the user when the user wishes to start recording part-way-through a broadcast program, since the user checks a rebroadcast schedule of the broadcast program that the user wants to record and watches or records the rebroadcast program.

### SUMMARY OF THE INVENTION

Illustrative, non-limiting exemplary embodiments of the present invention overcome the above disadvantages, and other disadvantages no described above.

An apparatus consistent with the present invention provides for recording a non-recorded part of a partly recorded broadcast program.

The present invention also provides a method and apparatus for recording a non-recorded part of a partly recorded broadcast program when a user does not select recording of the broadcast program, by automatically recording the broadcast program and determining a user's decision whether to record the broadcast program at the time when the user begins to record the broadcast program.

According to an aspect of the present invention, there is provided a broadcast program recording apparatus, comprising: a control unit, which when a broadcast program that a user is watching is selected to be recorded and at least a part of the broadcast program is not recorded, requests compensation for the non-recorded part of the broadcast program; the program compensator recording the non-recorded part of the broadcast program at the request of the control unit; and a storage unit storing the recorded broadcast program.

The program compensator may search whether the broadcast program including the non-recorded part will be rebroadcasted at the request of the control unit and provides the control unit with a result of the searching.

The broadcast program including the non-recorded part is rebroadcasted, the control unit records the rebroadcast program using the result obtained by the searching and compensates for the non-recorded part of the broadcast program.

The program compensator may search whether the broadcast program including the non-recorded part will be rebroadcasted using electronic program guide (EPG) information included in broadcast signals.

The program compensator may further comprise a rebroadcast requesting unit requesting the broadcast program including the non-recorded part to be rebroadcasted.

The control unit automatically may start recording of a broadcast program when power is turned on or a channel is changed and, when the user chooses to record the broadcast program that the user is watching before the broadcast program ends, the control unit requests the program compensator to compensate for the non-recorded part of the broadcast program.

The control unit may check the storage capacity of the storage unit and, if the storage capacity of the storage unit is not sufficient for the recording of the broadcast program, searches for another storage device connected via a network, etc.

According to another aspect of the present invention, there is provided a broadcast program recording method, comprising: when a broadcast program is partly recorded, searching whether the broadcast program will be rebroadcasted and obtaining rebroadcast information to compensate for the partly recorded broadcast program; and recording a rebroadcast program of the broadcast program using the rebroadcast information and compensating for the partly recorded broadcast program.

The compensating for the partly recorded broadcast program may be requested when the user chooses to record the broadcast program that the user is watching before the broadcast program ends.

The whether the broadcast program will be rebroadcasted may be searched using EPG information included in broadcast signals.

The partly recorded broadcast program may be compensated by requesting a broadcast program provider to rebroadcast the broadcast program and recording the rebroadcast program of the broadcast program.

The broadcast program recording method may further comprise checking the storage capacity necessary for the recording of the broadcast program, and if the storage capacity is not sufficient for the recording of the broadcast program, searching for another storage device connected via a network.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a broadcast program recording apparatus according to an embodiment of the present invention;

FIG. 2 is a block diagram illustrating a program compensator shown in FIG. 1;

FIG. 3 is a flowchart illustrating a broadcast program recoding method according to an embodiment of the present invention; and

FIG. 4 is a block diagram of a broadcast program recording apparatus according to another embodiment of the present invention.

### DETAILED DESCRIPTION OF THE INVENTION

The present invention will now be described more fully with reference to the accompanying drawings.

FIG. 1 is a block diagram of a broadcast program recording apparatus 100 according to an embodiment of the present invention. The broadcast program recording apparatus 100 automatically starts recording a broadcast program that a user is watching, even if where the user does not choose to record the broadcast program, and then compensates a non-recorded part of the broadcast program when the user chooses to record the broadcast program that the user is watching.

Referring to FIG. 1, the broadcast program recording apparatus 100 includes a tuner unit 110, a demultiplexer 120, a decoder 130, a program compensator 140, a user interface 150, a control unit 160, and a storage unit 170.

The tuner unit 110 tunes and demodulates a broadcast signal that is input on a specific channel that a user chooses, and outputs a transport (TP) stream comprising multiplexed information.

The demultiplexer 120 demultiplexes the TP stream output by the tuner unit 110 into a video TP stream, an audio TP stream, and EPG information.

The decoder 130 receives and decodes the video/audio TP streams separated by the demultiplexer 120 to output video/audio signals.

The control unit 160 controls the tuner unit 110 to receive the broadcast signal of the specific channel that the user chooses among broadcast signals received via an antenna or a cable network. The control unit 160 controls the broadcast program that the user is watching to be automatically recorded in the storage unit 170. The control unit 160 automatically starts the recording of the broadcast program that the user is watching regardless of whether or not the broadcast program is scheduled to be recorded or the user chooses to instantly record the broadcast program. If the user performs the recording of the broadcast program that the user is watching as soon as the user wants to record the broadcast program, since a considerable part of the broadcast program has been broadcasted, the recording is previously started in order to prepare the user to choose to record the broadcast program that the user is watching later. When the user changes a channel using the user interface 150, the control unit 160 cancels the recording of a broadcast program that was already recorded and performs recording of a broadcast program of the new channel.

When the user starts a recording operation before the broadcast program ends, the control unit 160 determines that the user wants to record the broadcast program that the user is watching and starts the recording of the broadcast program. To be more specific, when the user starts recording the broadcast program that the user is watching by pressing an instant record key included in the user interface 150, the control unit 160 requests the program compensator 140 to compensate for a non-recorded part of the broadcast program.

The program compensator 140 compensates for a non-recorded part of a partially recorded broadcast program. As described above, since the control unit 160 starts the recording of a broadcast program that the user is watching, the broadcast program is not wholly but partly recorded when the recording is started in the middle of the broadcast program or after a channel is changed. Therefore, the program compensator 140 compensates for the non-recorded part of the broadcast program such that the user can watch a completely recorded broadcast program.

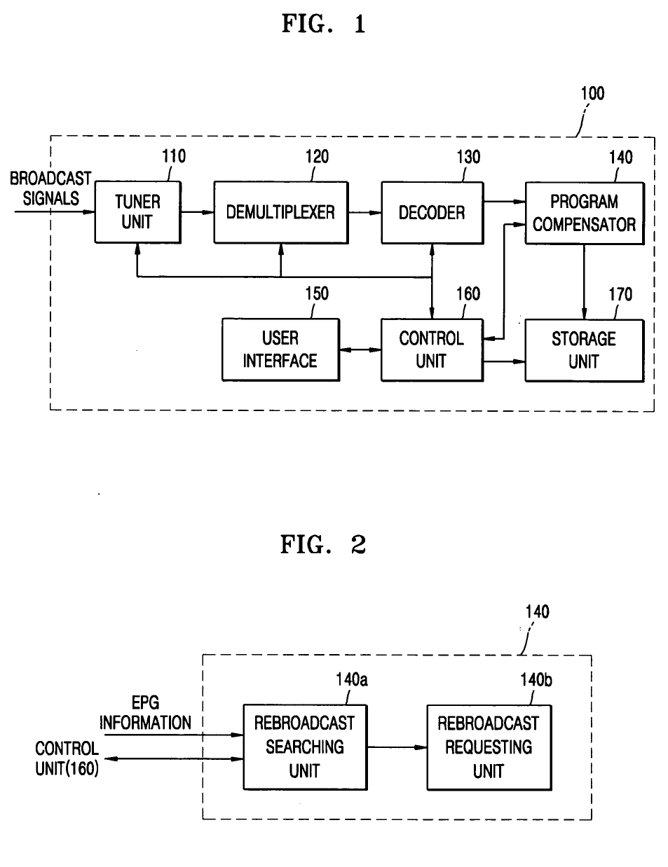

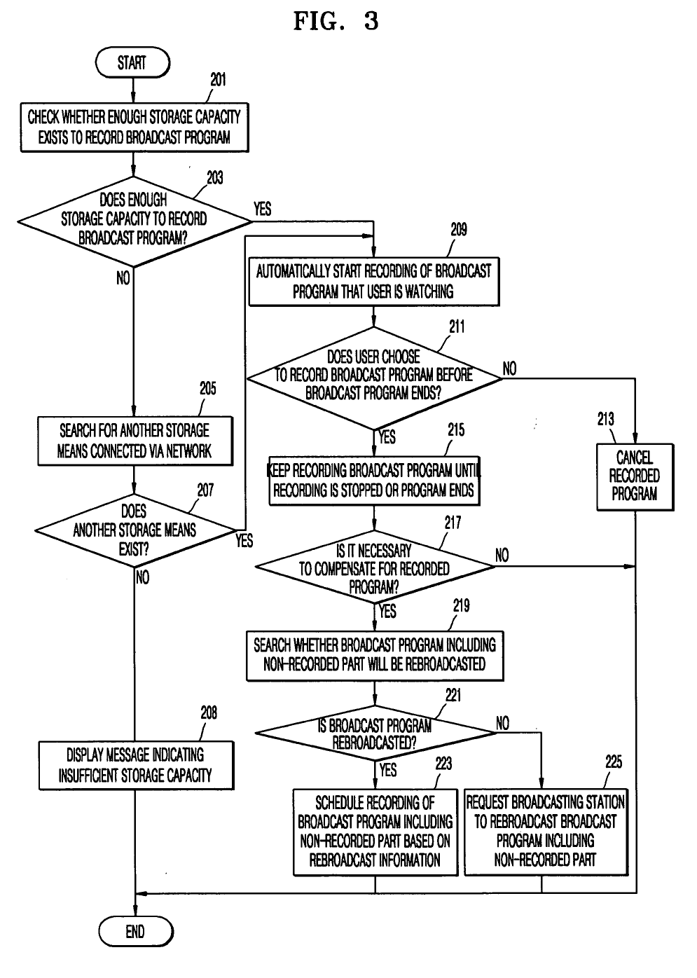

FIG. 2 is a block diagram illustrating the program compensator 140 shown in FIG. 1. Referring to FIG. 2, the program compensator 140 includes a rebroadcast searching unit 140a and a rebroadcast requesting unit 140b.

The rebroadcast searching unit 140a searches whether the non-recorded program will be rebroadcasted using EPG information included in broadcast signals. A broadcasting station multiplexes the EPG information, which includes a program title, broadcast time information, program rating information, and fee information, with broadcast signals and transmits the information to users. The rebroadcast searching unit 140a searches whether the program including the non-recorded part will be rebroadcasted using the EPG information and outputs the rebroadcast information to the control unit 160. The rebroadcast information may include at least rebroadcast time information.

The control unit 160 receives the rebroadcast information from the rebroadcast searching unit 140a, automatically starts recording the broadcast program including the non-recorded part using the rebroadcast time information when the broadcast program including the non-recorded part is rebroadcasted, and compensates for the non-recorded part of the broadcast program. The control unit 160 may store the rebroadcast information in a predetermined memory and the memory may be a read only memory (ROM).

If the rebroadcast searching unit 140a determines that the broadcast program including the non-recorded part will not be rebroadcasted, the rebroadcast requesting unit 140b directly requests the broadcasting station to rebroadcast the broadcast program including the non-recorded part. It is widely known that digital broadcasting makes two-way broadcasting, i.e., interactive broadcasting, rather than conventional one-way broadcasting, possible. Therefore, the rebroadcast requesting unit 140b requests the broadcasting station to rebroadcast the broadcast program including the non-recorded part to compensate for the non-recorded part of the broadcast program.

Under the control of the control unit 160, the storage unit 170 compresses the broadcast program that the user is watching into a predetermined format and stores it. The storage unit 170 may be a storage medium, such as a hard disk, having a large capacity. Meanwhile, the control unit 160 can check the storage capacity of the storage unit 170 and, if the storage capacity of the storage unit 170 is not sufficient for recording the broadcast program, searches for another storage device connected via a network, etc.

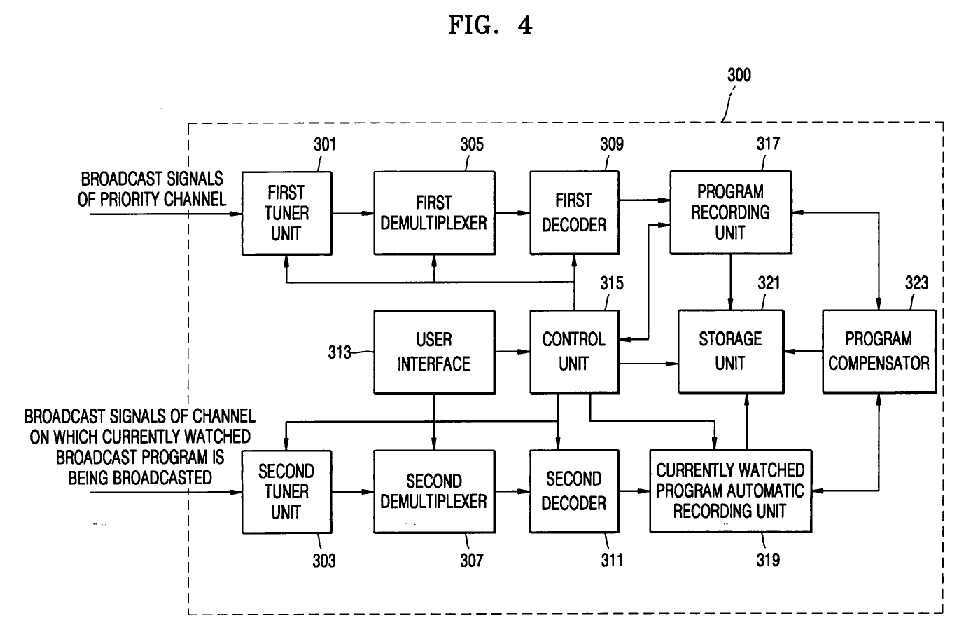

FIG. 3 is a flowchart illustrating a broadcast program recoding method according to an embodiment of the present invention. Referring to FIG. 3, the control unit 160 checks if the storage unit 170 has enough storage capacity to record a broadcast program that the user is watching (Operation 201 and 203). If the control unit 160 determines that the storage capacity of the storage unit 170 is not enough to record the broadcast program, it searches for another storage means connected via the network (Operation 205) and, if it finds a network storage means, uses it for recording the broadcast program. If the control unit 160 determines that the storage capacity of the storage unit 170 is not enough to record the broadcast program and fails to find another storage means in Operation 207, it displays a message indicating insufficiency of storage capacity to the user through an On Screen Display (OSD) (Operation 208).

If the control unit 160 determines that the storage capacity of the storage unit 170 is enough to record the broadcast program, it automatically starts recording the broadcast program that the user is watching (Operation 209).

Then, the control unit 160 determines whether the user chooses to record the broadcast program before the broadcast program ends (Operation 211). When the user chooses to record the broadcast program before the broadcast program ends, the control unit 160 determines that the user wants to record the broadcast program that the user is watching and keeps recording the broadcast program until the recording is stopped or the program ends (Operation 215), and determines whether the program is completely recorded (Operation 217). When the recording has stopped or the program has ended, the control unit 160 determines whether it is necessary to compensate for the recorded program. For example, whether compensation is necessary is determined by comparing broadcast program time with record time of the broadcast program in the control unit 160 or the program compensator 140 using the EPG information.

If the control unit 160 determines that the user does not choose to record the broadcast program before the broadcast program ends, it determines that the user does not want to record the broadcast program that the user is watching and automatically cancels the recorded program (Operation 213).

In Operation 217, if the control unit 160 determines that it is necessary to compensate for the recorded program, the rebroadcast searching unit 140a searches whether the broadcast program including the non-recorded part will be rebroadcasted using the EPG information included in broadcast signals (Operation 219).

If it is determined in Operation 219 that the program including the non-recorded part is scheduled to be rebroadcasted, the rebroadcast searching unit 140a provides the control unit 160 with rebroadcast information. The control unit 160 schedules the recording of the program including the non-recorded part based on the rebroadcast information and records the rebroadcast program when it is rebroadcasted to compensate for the non-recorded part of the broadcast program.

If it is determined in Operation 219 that the program including the non-recorded part is not scheduled to be rebroadcasted, the rebroadcast requesting unit 140b requests the broadcasting station to rebroadcast the program including the non-recorded part and records the rebroadcast program when it is rebroadcasted to compensate for the non-recorded part of the broadcast program (Operation 225).

FIG. 4 is a block diagram of a broadcast program recording apparatus 300 according to another embodiment of the present invention. In comparison with the broadcast program recording apparatus 100, the broadcast program recording apparatus 300 includes at least two tuner units, automatically records a broadcast program according to a channel priority order previously set by the user independent of a broadcast program that a user is watching, and compensates for a non-recorded part of the broadcast program when the user chooses to record the broadcast program.

Referring to FIG. 4, the broadcast program recording apparatus 300 includes first and second tuner units 301 and 303, first and second demultiplexers 305 and 307, first and second decoders 309 and 311, a user interface 313, a control unit 315, a program recording unit 317, a currently watched program automatic recording unit 319, a storage unit 321, and a program compensator 323.

The first tuner unit 301 receives broadcast signals according to the channel priority order previously set by the user, independently of a broadcast channel on which a broadcast program that the user is watching is being broadcasted. The second tuner unit 302 receives broadcast signals of a broadcast channel on which a broadcast program that the user chooses to watch via the user interface 313 is being broadcasted. The two tuner units are required to record a changed broadcast channel when the channel on which the broadcast program that the user is watching is changed to another channel.

The first and second demultiplexers 305 and 307 demultiplex TP streams output by the first and second tuner units 301 and 303 into video TP streams, audio TP streams, and EPG information.

The first and second decoders 309 and 311 receive and decode video/audio TP streams separated by the first and second demultiplexers 305 and 307 to output video/audio signals.

The program recording unit 317 automatically records a broadcast program according to the channel priority order previously set by the user. The currently watched program automatic recording unit 319 automatically records a broadcast program that the user is currently watching. The user stores broadcast programs in the program recording unit 317 according to the channel priority order previously set by himself/herself, and the program recording unit 317 automatically records a broadcast program according to the channel priority order, independently of the broadcast program that the user is watching. The program recording unit 317 can record a broadcast program being broadcasted on a highest priority channel other than the channel that the user is watching.

For example, if it is assumed that the user sets a channel priority in the order of the SBS channel, MBC channel, KBS channel 2, and KBS channel 1, when the user is watching a broadcast program being broadcasted on the MBC channel, under the control of the control unit 315, the program recording unit 317 records a broadcast program being broadcasted on the first priority channel, i.e., the SBS channel, and the currently watched program automatic recording unit 319 records the broadcast program being broadcasted on the MBC channel. At this time, when the user changes the MBC channel to the SBS channel and chooses to record the broadcast program being broadcasted on the SBS channel, the broadcast program already recorded by the program recording unit 317 compensates for a part of the broadcast program that was not recorded before the user started the recording of the broadcast program. If the user is watching the broadcast program being broadcasted on the first priority channel, i.e., the SBS channel, the program recording unit 317 records the broadcast program being broadcasted on the second priority channel, i.e., the MBC channel, and the currently watched program automatic recording unit 319 records the broadcast program being broadcasted on the SBS channel.

The currently watched program automatic recording unit 319 automatically records a broadcast program that the user is currently watching and keeps recording a broadcast program being broadcasted on a channel to which the user has changed. If the broadcast program being broadcasted on the channel to which the user has changed is being recorded by the program recording unit 317, the program recording unit 317 records a broadcast program being broadcasted on a next priority channel or the currently watched program automatic recording unit 319 transfers a part of the broadcast program that is already recorded to the program recording unit 317 to keep controlling the recording of the broadcast program that the user is watching.

The control unit 315 controls the first tuner unit 301 to be tuned according to the channel priority order previously set by the user and the second tuner unit 303 to be tuned to a channel selected by the user via the user interface 313.

When the user chooses to record a broadcast program that the user is watching by pressing an instant record key included in the user interface 313, the control unit 315 requests the program compensator 323 to compensate for the broadcast program being recorded.

Meanwhile, the control unit 315 checks the storage capacity of the storage unit 321 and searches for another storage device connected via a network.

When the program compensator 323 is requested to compensate for the recorded broadcast program by the control unit 315, it determines whether there is a non-recorded part in the recorded broadcast program. The specific constitution and operation of the program compensator 323 is similar to those of the program compensator 140 shown in FIG. 1. That is, the program compensator 323 includes a rebroadcast searching unit and a rebroadcast requesting unit.

While the user is watching the broadcast program, the program compensator 323 determines whether the program recording unit 317 has completely recorded the broadcast program that is selected to be recorded by the user according to the channel priority order. If the program compensator 323 determines that the program recording unit 317 has completely recorded the broadcast program, it does not compensate for the recording. If the program compensator 323 determines that the program recording unit 317 has partly recorded the broadcast program, the rebroadcast searching unit of the program compensator 323 searches whether the broadcast program including the non-recorded part will be rebroadcasted. As described above, the EPG information included in broadcast signals are used to search whether the broadcast program including the non-recorded part will be rebroadcasted.

As a result of the searching, if the program including the non-recorded part is scheduled to be rebroadcasted, the rebroadcast searching unit provides the control unit 315 with rebroadcast information. The control unit 315 records the rebroadcast program at a scheduled rebroadcast time to compensate for the non-recorded part of the broadcast program.

If the program including the non-recorded part is not scheduled to be rebroadcasted, the rebroadcast requesting unit requests a broadcasting station to rebroadcast the program including the non-recorded part and records the rebroadcast program in the storage unit 321 under the control of the control unit 315 when the broadcasting station rebroadcasts the program including the non-recorded part to compensate for the non-recorded part of the broadcast program.

The broadcast program recording apparatus and method according to the present invention can be used for time shifting. Time shifting is the recording of broadcast signals to some built-in storage medium to be viewed at a time convenient to the user. Time shifting is used to store broadcast content and thereafter contents while the user is away and reproduce them, at a time convenient to the user. When the user starts time shifting at the middle of a broadcast program, the present invention applies time shifting and compensates for a part of the broadcast program before the time shifting starts, thereby returning and reproducing the part before the time shifting starts.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

As described above, since the present invention automatically records a broadcast program from the time when a user watches the broadcast program, if the user instantly wants to record the broadcast program, the present invention compensates for a part of the broadcast program that was not recorded before the recording started, thereby completely recording the broadcast program. Even when the broadcast program is not scheduled to be rebroadcasted in a digital broadcast era, the present invention can request a broadcasting station to rebroadcast the broadcast program and compensate for an incompletely recorded program.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A broadcast program recording apparatus, comprising:
a control unit, which when a broadcast program that a user is watching is selected to be recorded and at least a part of the broadcast program is not recorded, requests compensation for the non-recorded part of the broadcast program;
the program compensator for recording the non-recorded part of the broadcast program at the request of the control unit; and
a storage unit for storing the recorded broadcast program.

2. The broadcast program recording apparatus of claim 1, wherein the program compensator searches whether the broadcast program including the non-recorded part will be rebroadcasted at the request of the control unit and provides the control unit with a result of the searching.

3. The broadcast program recording apparatus of claim 1, wherein, when the broadcast program including the non-recorded part is rebroadcasted, the control unit records the rebroadcast program using the result obtained by the searching and compensates for the non-recorded part of the broadcast program.

4. The broadcast program recording apparatus of claim 2, wherein the program compensator searches whether the broadcast program including the non-recorded part will be rebroadcasted using electronic program guide (EPG) information included in broadcast signals.

5. The broadcast program recording apparatus of claim 1, wherein the program compensator further comprises a rebroadcast requesting unit requesting the broadcast program including the non-recorded part to be rebroadcasted.

6. The broadcast program recording apparatus of claim 1, wherein the control unit automatically starts recording of a broadcast program when power is turned on or a channel is changed and, when the user chooses to record the broadcast program that the user is watching before the broadcast program ends, the control unit requests the program compensator to compensate for the non-recorded part of the broadcast program.

7. The broadcast program recording apparatus of claim 1, wherein the control unit checks the storage capacity of the storage unit and, if the storage capacity of the storage unit is not sufficient for the recording of the broadcast program, searches for another storage device connected via a network.

8. A broadcast program recording apparatus, comprising:
at least one tuner unit for receiving broadcast signals;
a program recording unit for recording a broadcast program that is input by one of the tuner units according to a channel priority order previously set by a user;
a currently watched program automatic recording unit for recording a broadcast program that is input by another of the tuner units and that the user is watching;
a control unit, which when the broadcast program that the user is watching is selected to be recorded and at least a part of the broadcast program is not recorded, requests compensation for the non-recorded part of the broadcast program;
the program compensator for recording the non-recorded part of the broadcast program at the request of the control unit; and
a storage unit for storing the broadcast program recorded by the program recording unit and the watching program automatic recording unit.

9. The broadcast program recording apparatus of claim 8, wherein, when the broadcast program that the user is watching is changed due to a channel change, the program compensator compensates for the non-recorded part of the broadcast program using the broadcast program recorded by the program recording unit.

10. The broadcast program recording apparatus of claim 8, wherein the program compensator searches whether the broadcast program including the non-recorded part will be rebroadcasted at the request of the control unit and provides the control unit with a result of the searching.

11. The broadcast program recording apparatus of claim 10, wherein, when the broadcast program including the non-recorded part is rebroadcasted, the control unit records the rebroadcast program using the result of the searching and compensates for the non-recorded part of the broadcast program.

12. The broadcast program recording apparatus of claim 10, wherein the program compensator searches whether the broadcast program including the non-recorded part will be rebroadcasted using EPG information included in broadcast signals.

13. The broadcast program recording apparatus of claim 8, wherein the program compensator further comprises a rebroadcast requesting unit for requesting the broadcast program including the non-recorded part to be rebroadcasted.

14. The broadcast program recording apparatus of claim 8, wherein the control unit automatically starts recording of a broadcast program when power is turned on or a channel is changed and, when the user chooses to record the broadcast program that the user is watching before the broadcast program ends, the control unit requests the program compensator to compensate for the non-recorded part of the broadcast program.

15. The broadcast program recording apparatus of claim 8, wherein the control unit checks the storage capacity of the storage unit and, if the storage capacity of the storage unit is not sufficient for the recording of the broadcast program, searches for another storage device connected via a network.

16. A broadcast program recording method, comprising:
when a broadcast program is partly recorded, searching whether the broadcast program will be rebroadcasted and obtaining rebroadcast information to compensate for the partly recorded broadcast program; and
recording a rebroadcast program of the broadcast program using the rebroadcast information and compensating for the partly recorded broadcast program.

17. The broadcast program recording method of claim 16, wherein the compensating for the partly recorded broadcast program is requested when the user chooses to record the broadcast program that the user is watching before the broadcast program ends.

18. The broadcast program recording method of claim 16, wherein the whether the broadcast program will be rebroadcasted is searched using EPG information included in broadcast signals.

19. The broadcast program recording method of claim 16, wherein the partly recorded broadcast program is compensated by requesting a broadcast program provider to rebroadcast the broadcast program and recording the rebroadcast program of the broadcast program.

20. The broadcast program recording method of claim 16, further comprising checking the storage capacity necessary for the recording of the broadcast program, and if the storage capacity is not sufficient for the recording of the broadcast program, searching for another storage device connected via a network.
